(19) United States
(12) Patent Application Publication
(10) Pub. No.: US 2021/0379612 A1
(43) Pub. Date: Dec. 9, 2021

(54) SET OF NOZZLES FOR A SPRAY GUN, SPRAY GUN SYSTEM, METHOD FOR EMBODYING A NOZZLE MODULE, METHOD FOR SELECTING A NOZZLE MODULE FROM A SET OF NOZZLES FOR A PAINT JOB, SELECTION SYSTEM AND COMPUTER PROGRAM PRODUCT

(71) Applicant: SATA GMBH & CO. KG, Kornwestheim (DE)

(72) Inventors: Eva VOLK, Ludwigsburg (DE); Michael PANTLE, Gemmrigheim (DE); Norbert MAIER, Allmersbach im Tal (DE); Mazin MASHALLA, Stuttgart (DE)

(73) Assignee: SATA GMBH & CO. KG, Kornwestheim (DE)

(21) Appl. No.: 17/264,372

(22) PCT Filed: Aug. 1, 2018
(86) PCT No.: PCT/DE2018/100679

§ 371 Date: Jan. 29, 2021

(51) Int. Cl. B05B 7/08; B05B 1/14; B05B 1/04

(52) U.S. Cl. CPC B05B 7/0815; B05B 1/044; B05B 1/14

(57) ABSTRACT

A set of nozzles for a spray gun, especially a compressed-air paint spray gun, comprises at least one nozzle module group with at least two different nozzle modules for mounting in or on the same base module of a spray gun. The nozzle modules have different medium flow rates under the same spray conditions, the spray jets generated by the nozzle modules having substantially the same spray jet section height and the same spray jet section width, the spray jet sections of the different nozzle modules in particular being congruent. A spray gun system, a method for embodying a nozzle module, a method for selecting a nozzle module from a set of nozzles for a paint job, a selection system, in particular a “slide gate system”, and a computer program product are also disclosed. The user can select the nozzle module which is ideal for the paint job and mode of operation in question.

### FIELD OF THE INVENTION

The present invention relates to a set of nozzles for a spray gun, especially a compressed-air atomizing paint spray gun, a spray gun system, a method for embodying a nozzle module, a method for selecting a nozzle module from set of nozzles for a paint job, a selection system, especially a “slide gate system,” and a computer program product.

### BACKGROUND

According to the prior art, spray gun, especially a paint spray gun, in particular a compressed-air atomizing paint spray gun which is also referred to as compressed-air atomizing paint gun, comprises a spray medium nozzle disposed on the head thereof, which is also known as a paint nozzle and which is screwed into the gun body. On its front end, the spray medium nozzle frequently has a small hollow-cylindrical peg, i.e., a substantially hollow-cylindrical front section, from the front muzzle, i.e., from the spray medium outlet of which the medium to be sprayed exits during operation. However, the front portion of the spray medium nozzle can also have a conical shape. As a rule, the head of the gun has an external thread, by means of which an air nozzle ring with an integrated air cap is screwed onto the head of the gun. The air cap has a central aperture, the diameter of which is larger than the outside diameter of the peg of the spray medium nozzle or the outside diameter of the front end of a conical spray medium nozzle. The central aperture of the air cap and the small peg or the front end of the spray medium nozzle together form an annular gap. Exiting from this annular gap is the so-called atomizing air which, in the above-described nozzle configuration, generates a vacuum on the front face surface of the spray medium nozzle, which causes the medium to be sprayed to be sucked out of the spray medium nozzle. The atomizing air strikes the paint jet, which causes the paint jet to be sheared into strings and ribbons. Due to their hydrodynamic instability, the interaction between the rapidly flowing compressed air and the ambient air, and due to aerodynamic disturbances, these strings and ribbons disintegrate into droplets which are blown away from the nozzle by the atomizing air.

Further, the air cap frequently has two horns which are disposed diametrically opposite to one another and which, in the outflow direction, project beyond the aforementioned annular gap and the spray medium outlet aperture. From the rear surface of the air cap, two supply bores, i.e., horn air inlet channels, extend to horn air outlet apertures in the horns. As a rule, each horn has at least one horn air outlet aperture; preferably, however, each horn has at least two horn air outlet apertures, from which the horn air exits. As a rule, the horn air outlet apertures are oriented such that they point to the longitudinal axis of the nozzle in the exit direction after the annular gap so that the so-called horn air exiting from the horn air outlet apertures is able to influence the air or the paint jet that has already exited from the annular gap or the paint mist which has at least in part already been generated. As a result, the paint jet or spray jet with an originally round cross section (round jet) is compressed along the sides that face the horns and is lengthened in a direction perpendicular thereto. This creates a so-called wide jet which makes it possible to paint large surfaces at a higher speed. In addition to deforming the spray jet, the horn air has the purpose of further atomizing the spray jet.

As a rule, the above-mentioned spray medium nozzle comprises a hollow main section and a substantially hollow-cylindrical front section with an outlet aperture for the spray medium, with the medium to be sprayed flowing through said outlet aperture. Depending on the type of medium to be sprayed and the preference of the user of the spray gun, the spray gun can be fitted with spray medium nozzles having spray medium outlet apertures of different sizes, i.e., spray medium outlet apertures having inside diameters of different sizes. As a rule, if the medium to be sprayed, e.g., paint, is a relatively high-viscosity medium, for example, a filler, a spray medium nozzle having a spray medium outlet aperture with an inside diameter larger than that for a low-viscosity material such as varnish should be used. Generally, the inside diameter of a spray medium outlet aperture of a spray medium nozzle measures between a few tenths of a millimeter and several millimeters. A spray medium nozzle with a spray medium outlet aperture having a defined inside diameter is frequently referred to as a spray medium nozzle having a defined “nozzle size,” with the value of this nominal nozzle size not necessarily having to correspond exactly to the value of the inside diameter of the spray medium outlet aperture.

Depending on the nozzle size, i.e., depending on the size of the inside diameter of the spray medium outlet aperture of the spray medium nozzle, the spray medium nozzle or the spray gun fitted with the spray medium nozzle, can have a defined medium flow rate. The medium flow rate is the amount of medium which exits from the spray medium nozzle of the spray gun within a defined period of time at a defined inlet flow pressure and a fully actuated trigger position. The value is given in grams per minute (g/min). With all other parameters remaining the same, the medium flow rate increases with increasing nozzle size, with the medium flow rate being influenced not only by the inside diameter of the spray medium outlet aperture but also by the length of the hollow-cylindrical front section, the configuration of the various surface areas inside the spray medium nozzle, especially by the angles at which the surface areas are arranged relative to each other, and by different embodiments of the spray medium nozzle.

In spray guns according to the prior art, the size of the spray jet generated by the spray gun, especially the height and/or the width of the spray jet or the spray jet section, changes as the medium flow rate increases. The spray jet section can be visualized by means of a so-called spray image. A spray image is generally generated in that, using a spray gun at a defined distance, for example, 15 cm to 20 cm from a substrate, for example, paper, a sheet of scaled paper provided for generating a spray image, or a metal sheet, paint or varnish is applied to this sheet of paper or metal sheet without moving the spray gun. The spraying time measures approximately 1 to 2 seconds. The shape of the spray image thus generated and the size of the droplets on the substrate provide information about the quality of the spray gun, especially about the quality of the nozzles.

The coating thickness of the spray image can be measured by means of the procedures known from the prior art, for example, by means of coating thickness gauges before or after the spray image has dried, or the paint droplets and their size and position are determined while they are still traveling to the substrate, e.g., by means of laser diffraction methods.

A spray image like the one described above does not have a uniform coating thickness across the length and width thereof. The central core of the spray image has a high coating thickness; outside the core, the coating thickness generated is lower. The coating thickness transition from the core to the outer zone is fluid. Plotting the coating thickness across the length of the spray image from left to right results in an initially flat slope which marks the outermost edge of the outer zone. In the vicinity of the core, the coating thickness increases relatively sharply and, in the ideal case, remains substantially constant along the linear extension of the core, i.e., it reaches a plateau. At the edge of the core, the coating thickness drops relatively sharply, followed by a flattening of the curve toward the end of the outer zone. It has been shown that a uniform, higher quality coating can be obtained, the sharper the transition from the core to the outer zone, i.e., the steeper the profile of the coating thickness along the length of the spray image in the transition area from the outer zone into the core zone. During the painting procedure, the painter moves the actuated spray gun in meandering paths, which overlap over approximately between 30% to 50% of their height, i.e., approximately the lower or upper third of a path overlaps the upper or lower third of the preceding path. A more sharply defined core zone allows the painter to coat the core zones of the spraying paths during the painting procedure as contiguously as possible so that a uniform overall coating thickness is obtained. However, in order to avoid the risk of overcoating, e.g., by unintentionally applying twice the coating thickness, which can lead to so-called paint runs, the transition should not be overly abrupt. The tests have also shown that it is beneficial if the above-mentioned plateau is as wide as possible, i.e., if the core zone of the spray image with the maximum coating thickness is as long as possible.

In the case at hand, the spray image is intended to constitute the spray jet section. Hereinafter, whenever the terms spray jet section height, spray jet section width or cross-sectional shape of the spray jet are used, these terms shall be deemed to refer to the height, the width and the shape of the spray image, especially the height, the width and the shape of the core zone of the spray image.

As already mentioned above, in prior-art spray guns, the size of the spray jet generated by the spray gun, especially the height and/or the width of the spray jet or the spray jet section or the spray jet core section changes as the medium flow rate increases. With increasing nozzle size and/or increasing medium flow rate, the spray jet not only becomes “wetter” as desired, i.e., more spray medium per surface area is applied, but the spray jet section increases in height and/or in width. Further, the medium flow rate does not uniformly increase with increasing nozzle size, especially nominal nozzle size. For example, a so-called 1.2 nozzle can have a medium flow rate that is higher by 10 g/min than that of a 1.1 nozzle, but a medium flow rate that is lower by 20 g/min than that of a 1.3 nozzle. Thus, anytime a nozzle is replaced, users of the spray gun must adapt their mode of operation to the new nozzle. For example, if the user wishes to spray a spray medium having a defined viscosity and subsequently a spray medium having a different viscosity and therefore switches from one nozzle size to a different nozzle size, the user will have to adjust, for example, the distance of the spray gun relative to the surface area to be coated or the painting speed, i.e., the speed at which the user moves the spray gun across the surface area to be coated, to the new nozzle. This can complicate the job of the user of the spray gun. In addition, users of prior-art spray guns do not have the option to use a jet shape best suited to them and their mode of operation, i.e., a spray jet section best suited to them.

### SUMMARY OF THE INVENTION

Thus, one aspect of the invention relates to a set of nozzles for a spray gun, in particular a compressed-air atomizing paint spray gun, and a spray gun system, which offer the user greater consistency in the painting results.

Another aspect of the present invention relates to an efficient method for embodying a nozzle module.

Another aspect of the present invention relates to an efficient method for selecting a nozzle module.

Yet another aspect of the present invention relates to an efficient selection system, especially a “slide gate system.”

An additional aspect of the present invention relates to a functionally reliable computer program product.

Disclosed is a set of nozzles for a spray gun, in particular a compressed-air atomizing paint spray gun, which comprises at least one nozzle module group with at least two, preferable at least four, different nozzle modules for optional mounting in or on one and the same base module of a spray gun, with the nozzle modules being designed such that they have a different medium flow rate under the same spray conditions and with the spray jets generated by means of the nozzle modules having substantially the same spray jet height and the same spray jet section width, in particular, with the spray jet sections of the different nozzle modules being congruent.

The nozzle modules within the nozzle module group each have a different medium flow rate, in particular, the nozzles have different nozzle sizes, especially nominal nozzle sizes. The nozzle module group can comprise, for example, a 1.1 nozzle module, a 1.2 nozzle module, a 1.3 nozzle module, a 1.4 nozzle module and a 1.5 nozzle module, the medium flow rate of which modules increases as the nominal nozzle size increases. The nominal nozzle size can be substantially equivalent to the actual nozzle size, i.e., to the actual inside diameter of the outlet aperture of the paint nozzle of the nozzle module in millimeters. Thus, for example, the inside diameter of the 1.5 nozzle module can measure 1.5 mm. However, the inside diameter of the spray medium outlet aperture of the paint nozzle of the 1.3 nozzle module can, for example, measure 1.4 mm, with the possibility of reducing the medium flow rate, as compared to that of the 1.4 nozzle module, for example, by using different geometries and/or dimensions, especially angles and lengths, especially the length of a substantially hollow-cylindrical front section of the paint nozzle. At the same time or as an alternative, the spray medium outlet aperture of the paint nozzle of the 1.4 nozzle module can have an inside diameter greater than 1.4 mm.

The at least two, preferably at least four different nozzle modules of the nozzle module group of the set of nozzles according to the invention can optionally be mounted in or on one and the same base module of a spray gun. This means that a first nozzle module mounted on the base module, for example, a nozzle module with a first medium flow rate, for example, a 1.2 nozzle module with a medium flow rate of 150 g/min, can be removed, in particular unscrewed, from the base module, preferably by means of a quick screw cap, and a different nozzle module from the nozzle module group of set of nozzles according to the invention with a second medium flow rate, for example, a 1.5 nozzle module with a medium flow rate of 195 g/min, can be mounted on the same base module, preferably by means of the same quick screw cap.

Under the same spray conditions, the nozzle modules of the nozzle module group of the set of nozzles according to the invention have different medium flow rates, and the spray jets generated by means of the nozzle modules have substantially the same spray jet section height and spray jet section width. The spray conditions referred to being the same include, for example, the inlet flow pressure, the air pressure at the inlet of the spray gun, the distance and angle of the spray gun relative to the object to be coated, the medium to be sprayed, the extent of trigger actuation, the setting of a round or wide jet control, as well as ambient conditions, such as temperature, air humidity and ambient pressure. As mentioned above, in the case at hand, the spray image is intended to constitute the spray jet section. In this context, reference to the spray jet section height and the spray jet section width as being substantially the same means that the height and the width of the spray image, especially the core of the spray image, i.e., the zone of the spray image with the greatest coating thickness, are substantially the same. Most preferably, the spray jet sections of the different nozzle modules are congruent, i.e., with respect to shape and size, the spray images are substantially identical. Because of the different medium flow rates of the nozzle modules, the coating thickness of the spray images differs.

A nozzle module can especially comprise a spray medium nozzle and an air cap. In addition, it can comprise an air nozzle ring, by means of which the nozzle module can be screwed onto the base module, and a paint needle for closing and opening the spray medium outlet aperture of the spray medium nozzle.

The advantage of the set of nozzles according to the invention is that the user of the spray gun, for example, a vehicle painter, when changing the nozzle size, i.e., when replacing the nozzle module, which is mounted on the base module of the spray gun and which has a first medium flow rate, with a nozzle module having a second medium flow rate, does not have to change the spray jet section height and spray jet section width. Using the newly mounted nozzle, the user preferably achieves a spray jet having the same cross-sectional shape and dimension achieved with the removed nozzle. Therefore, after replacing the nozzle, the painter does not have to change the mode of operation previously used, especially the distance of the spray gun from the object to be coated.

The spray gun system according to the invention is characterized in that it comprises at least one set of nozzles described above and further described below and a base module, said nozzle modules of the set of nozzles being interchangeably mounted on the base module.

Each of the different nozzle modules from the different nozzle module groups can be interchangeably mounted on one and the same base module. The different nozzle modules preferably have the same connecting means so that they can be directly mounted on the base module, for example, by means of a thread, in particular a trapezoidal thread which can be configured in the form of a quick screw cap or connector, or by means of a bayonet lock, a plug-in connector, or by means of another connecting means known in the prior art. It is, however, also conceivable for a first nozzle module to have a type of connecting means different from that of a second nozzle module, and for one of the nozzle modules to be mounted on the base module by means of an adapter.

The method according to the invention for embodying a nozzle module, especially a nozzle module for a set of nozzles described above and further described below, comprises, as at least one step, the specification of at least one spray jet section height and/or one spray jet section width and/or one spray jet section to be generated by the nozzle module, and, as at least one additional step, the construction of the nozzle module which generates a spray jet with the defined spray jet section height and/or spray jet section width and/or spray jet section, with the method comprising the construction of an air cap, in particular the adjustment of an external horn air outflow angle and/or an internal horn air outflow angle and/or a control bore distance to a medium flow rate and/or to an internal nozzle pressure of the nozzle module, with the external horn air outflow angle being the angle at which horn air flows out of an external horn air outlet aperture of the air cap relative to a vertical axis, with the vertical axis extending perpendicularly relative to a central axis of the air cap, with the internal horn air outflow angle being the angle at which horn air flows out of an internal horn air outlet aperture of the air cap relative to the vertical axis, and with the control bore distance being the distance between at least one control bore in the air cap and a central aperture in the air cap.

For example, in the first step, it can be defined that the spray jet to be generated by the nozzle module should have a spray jet section height of approximately 27 cm and/or a spray jet section width of approximately 4 cm and/or an oval, in particular an elliptical cross-sectional shape. Again, this refers to the height, the width and the shape of the spray image, especially the core of the spray image. Next, the nozzle module is constructed, which generates a spray jet with the defined spray jet section height, spray jet section width and/or shape of the spray jet section. In particular, this involves the construction of an air cap for the nozzle module. Such an air cap can especially have two horns which are disposed diametrically opposite to one another and which project in the forward direction, i.e., in the spray direction, beyond a central aperture in the air cap. From the rear surface of the air cap, two supply bores, i.e., horn air inlet channels, extend to horn air outlet apertures in the horns. Preferably, each horn has at least two horn air outlet apertures, from which the horn air exits. As already described above, the horn air outlet apertures are typically oriented such that the horn air exiting from the horn air outlet apertures can influence the air, which has already exited from the above-mentioned annular gap, and the paint jet or the paint mist which has at least in part already been generated. Such an air cap can also have control apertures in the zone next to the central aperture. However, these control apertures, which hereinafter will be referred to as control bores although they do not necessarily have to be configured as bores, but which preferably are bores, extend into the inside of the air cap and, from there, are supplied with air when the spray gun is being operated. The air exiting from the control bores, the so-called control air, strikes and deflects the horn air exiting from the horn air outlet apertures and fans out the horn air jet, i.e., it widens and weakens the horn air jet. The control air also acts on the round jet and causes a slight preliminary deformation as well as further atomization. In both cases, the control air contributes to further atomizing the paint jet and reduces the contamination of the air cap by spray mist since it carries this mist away from the air cap. In particular, the air cap can have three control bores disposed on two oppositely lying sides of the central aperture, which control bores are arranged in the shape of a triangle, with a apex of the triangle being oriented in the direction of the internal or external horn air outlet apertures, i.e., the bore, which forms the apex of the triangle, is preferably located in line with the internal horn air outlet apertures, the external horn air outlet apertures and the center of the central aperture in the air cap. The control bores can have the same diameter, preferably measuring between 0.45 mm and 0.65 mm. However, the air cap can also have only two control bores disposed on two oppositely lying sides of the central aperture, which control bores are preferably located in line and in line with the internal horn air outlet apertures, the external horn air outlet apertures and the center of the central aperture in the air cap.

The method according to the invention comprises, in particular, adjusting an external horn air outflow angle and/or an internal horn air outflow angle and/or a control bore distance to a medium flow rate and/or to an internal nozzle pressure of the nozzle module, with the external horn air outflow angle being the angle at which horn air flows out of an external horn air outlet aperture of the air cap relative to a vertical axis, with the vertical axis extending perpendicularly relative to a central axis of the air cap, with the internal horn air outflow angle being the angle at which horn air flows out of an internal horn air outlet aperture of the air cap relative to the vertical axis, and with the control bore distance being the distance between at least one control bore in the air cap and a central aperture in the air cap.

It is obvious that the horn air, after exiting from horn air outlet aperture, spreads and fans out slightly. In the case at hand, the horn air outflow angle is defined as the angle at which the major portion of the horn air or the center of the horn air jet exits relative to the vertical axis described. In particular, the horn air outflow angle can be the angle of the central axis of the horn air outlet channel, especially of the horn air outlet bore, the end of which forms the horn air outlet aperture, relative to the vertical axis. The central axis of the air cap, relative to which the vertical axis extends perpendicularly, extends especially through the center of the central aperture in the air cap.

If a control bore is located in line with the horn air outlet apertures, the control bore distance is here defined as the distance between the above-mentioned central axis of the air cap and an axis parallel to this central axis through the center of the respective control bore. Alternatively, the control bore distance is here defined as the distance between the above-mentioned central axis and an axis extending parallel to this central axis through a projection of the center of the respective control bore onto the sectional plane. The sectional plane preferably extends especially along the central axis of the air cap and through the centers of the horn air outlet apertures.

In the context of the method according to the invention, adjusting an external horn air outflow angle and/or an internal horn air outflow angle and/or a control bore distance to a medium flow rate and/or to an internal nozzle pressure of the nozzle module means that the external horn air outflow angle, the internal horn air outflow angle and/or the control bore distance must be dimensioned as a function of a medium flow rate and/or an internal nozzle pressure. For example, if a nozzle module with a first medium flow rate and/or a first internal nozzle pressure generates a spray jet with the defined spray jet section height and/or spray jet section width and/or cross-sectional shape because it has a suitable external horn air outflow angle, a suitable internal horn air outflow angle and/or a suitable control bore distance, it will be necessary to change the external horn air outflow angle, the internal horn air outflow angle and/or the control bore distance for a second median flow rate different from the first medium flow rate and/or a second internal nozzle pressure different from the first internal nozzle pressure in order to obtain a spray jet with the defined spray jet section height and/or spray jet section width and/or cross-sectional shape. The medium flow rate will be different especially if a nozzle with a different nozzle size is used. The internal nozzle pressure will be different especially if first a low-pressure nozzle module and subsequently a high-pressure nozzle module is used, or if first a low-pressure base module and subsequently a high-pressure base module is used. However, changes to the air cap can also have an influence on the internal nozzle pressure.

In the context of the present method, an external horn air outflow angle, an internal horn air outflow angle and/or a control bore distance of the air cap are precisely adjusted to the medium flow rate and/or the internal nozzle pressure of the nozzle module so as to ensure that the nozzle module generates a spray jet with the defined, i.e., desired, spray jet section height and/or spray jet section width and/or cross-sectional shape. The external horn air outflow angle of the first horn is preferably identical to the external horn air outflow angle of the second horn, the internal horn air outflow angle of the first horn is identical to the internal horn air outflow angle of the second horn, and the control bore distance or the control bore distances of the control bores on one side of the central aperture is/are identical to the control bore distance or the control bore distances of the control bores on the opposite side of the central aperture.

The method according to the invention for selecting a nozzle module from a set of nozzles described above and further described below for use for a paint job is characterized in that the method comprises at least the selection and/or specification of one or a plurality of the following attributes of the paint job: the previously used nozzle module of a set of nozzles as in one of claims 1 to 8, the previously used nozzle module of a different set of nozzles, the type of pressure spray painting technique, the spray gun model, the spray gun manufacturer, the type of medium to be sprayed, the viscosity of the medium to be sprayed, the recommendation of the manufacturer of the medium to be sprayed, the shape of the spray jet, the coating thickness, the ambient condition, the painting speed, the controllability and the nozzle size, and in that, based on the selection and/or specification, a proposal for a nozzle module of the set of nozzles is generated. The method can include a number of different steps in which different selection and specification options are considered. For example, in a first step, the selection and/or specification can focus on whether the proposal for a nozzle module of the set of nozzles should be generated based on a previously used nozzle module of a set of nozzles described above and further described below, a previously used nozzle module of a different set of nozzles, the type of medium to be sprayed and/or based on the coating thickness to be achieved, especially on the coating thickness to be achieved per spraying pass. Depending on the selection and/or specification, a number of different additional attributes of the paint job can be selected and/or specified. As an option of the type of medium to be sprayed, for example, a water-based paint, a solvent-based paint, a varnish or a 2-component paint can be selected or specified. As an option of the type of pressure spray painting technique, e.g., low-pressure techniques, in particular HVLP, or high-pressure techniques, in particular compliant technology can be selected or specified. As an option for the used nozzle size, a single nozzle size, for example, 1.1, 1.2 or 1.3, a range of nozzle sizes, for example, 1.0 to 1.2, 1.3 to 1.5, etc., can be selected or specified. The viscosity of the medium to be sprayed can be selected or defined as a numerical value or as a viscosity range, e.g., low viscosity, normal viscosity or high viscosity, preferably specifying a value range, especially the time in seconds it takes for the medium to completely drain from a standard size container, especially a DIN4 cup. As an option for the desired shape of the spray jet section, e.g., a spray jet with a cross section having, an at least in certain areas, a substantially constant width (I-jet) or a spray jet with a cross section having a substantially oval, in particular substantially elliptical shape (O-jet) can be specified or selected. The ambient conditions to be selected or specified can include, in particular, the temperature and/or the relative air humidity in the paint spray booth in which the nozzle module is to be used. The specification of the painting speed and the controllability can preferably be designed as mutually influencing slide controls which indicate whether the user attaches greater importance to high painting speed or to good controllability of the application. The sum of the value for the importance of the painting speed and the value for the importance of the controllability can, in particular, always equal 100%. If the user of the method according to the invention moves the slide control for painting speed up, the slide control for controllability automatically moves down. Thus, the settings can be, e.g., 0% painting speed and 100% controllability if the user attaches importance only to good controllability; it can be 100% painting speed and 0% controllability if the user attaches importance only to painting speed; or it can be 25% painting speed and 75% controllability, 50% painting speed and 50% controllability, 75% painting speed and 25% controllability. The specification can, in particular, be made in 1% increments. The proposal for a nozzle module of the set of nozzles, which is generated based on the selection and/or specification of one or a plurality of attributes of the paint job, is preferably output, especially displayed. Preferably, the method according to the invention provides for sending the proposal for a nozzle module of the set of nozzles by email or by means of another data transmission system.

The selection system according to the invention, especially a “slide-gate system,” for implementing the aforementioned method, is characterized in that it comprises selection and/or input means for selecting and inputting the attributes of the paint job as well as means for generating and presenting a proposal for a nozzle module of the set of nozzles. The selection system can consist, for example, of a plurality of elements which can be moved relative to each other, for example, elements made of paper or cardboard, which constitute the selection and/or input means for selecting and/or inputting the attributes of the paint job. Once the selection and input of the attributes of the paint job have been completed, the selection system according to the invention then presents the proposal for a nozzle module of the set of nozzles.

The computer program product according to the present invention is characterized in that it includes commands which, during the execution of the program by a data processing device, cause this program to generate a method and/or the steps of the selection system described above and further described below. In particular, the computer program product according to the invention can have a menu navigation which, complementary to the selection system described above and further described below and the method described above and further described below for selecting a nozzle module from a set of nozzles for a paint job, includes different steps with different selection and/or specification options. For example, in a first step, the selection and/or specification here again can focus on whether the proposal for a nozzle module of the set of nozzles should be generated based on a previously used nozzle module of a set of nozzles described above and further described below, a previously used nozzle module of a different set of nozzles, the type of medium to be sprayed, and/or based on the coating thickness to be achieved, especially on the coating thickness to be achieved per spraying pass. Depending on the selection and/or specification, a number of different additional menu items can appear, by means of which the attributes of the paint job can be selected and/or defined. Issues discussed above in the context of the description of the method according to the invention apply mutatis mutandis to the computer program product according to the invention. The data processing device mentioned can especially be a smartphone or a desktop, notebook or tablet computer. The computer program product according to the invention can be designed such that the proposal for a nozzle module of the set of nozzles, which is generated based on the selection and/or specification of one or a plurality of attributes of the paint job, is output and, in particular, displayed. Most preferably, the computer program product according to the invention is designed such that the proposal for a nozzle module of the set of nozzles can be sent per email or by means of another data transmission system.

Advantageous embodiments are also disclosed.

The set of nozzles according to the invention preferably includes at least one additional (second) nozzle module group which comprises at least two, preferably at least four, different nozzle modules for optional mounting in or on one and the same base module, with the nozzle modules of the additional nozzle module group also being designed such that they have different medium flow rates under the same spray conditions and that the spray jets generated by means of the nozzle modules have substantially the same spray jet section height and the same spray jet section width, and that, in particular, the spray jet of the different nozzle modules are congruent, with the spray jets generated by means of the nozzle modules of the two nozzle module groups each having different cross-sectional shapes, in particular such that the spray jets generated by means of the nozzle modules of one nozzle module group have a cross section having, in an at least certain areas, a substantially constant width (I-nozzle modules) and the spray jets generated by means of the nozzle modules of the different nozzle module group have a cross section with a substantially oval, in particular substantially elliptical shape (O-nozzle modules).

The above explanations in respect of the set of nozzles according to the invention here apply mutatis mutandis.

Like the above-described nozzle module group of the set of nozzles according to the invention, which will hereinafter be referred to as the first nozzle module group, the additional, or more specifically second, nozzle module group also comprises at least two, preferably at least four, different nozzle modules for optional mounting in or on one and the same base module, with the nozzle modules of the additional nozzle module group also being designed such that they have different medium flow rates under the same spray conditions and that the spray jets generated by means of the nozzle modules have substantially the same spray jet section height and the same spray jet section width, and that, in particular, the spray jets sections of the different nozzle modules are congruent.

Further, the spray jets generated by means of the nozzle modules of the two nozzle module groups, i.e., the first nozzle module group and the additional, or more specifically second, nozzle module group, each have different cross-sectional shapes, in particular such that the spray jets generated by means of the nozzle modules of one nozzle module group have a cross section having, in an at least certain areas, a substantially constant width (I-nozzle modules) and the spray jets generated by the other nozzle module group have a cross section with a substantially oval, in particular substantially elliptical shape (O-nozzle modules). The nozzle modules generating spray jets with a cross section having, at least in certain areas, a substantially constant width will hereinafter be referred to as I-nozzle modules, and a spray jet generated by means of an I-nozzle module will be referred to as I-jet. The nozzle modules with spray jets having a substantially oval, in particular substantially elliptical shape will hereinafter be referred to as O-nozzle modules, and a spray jet generated by means of an O-nozzle module will be referred to as O-jet. An I-jet is distinguished by an elongated jet shape with short tapered zones at the top and bottom in the spray image, which is the reason why an I-jet is especially well suited for a controlled application, in particular because, at a defined painting speed, a smaller amount of paint per surface area is applied. An O-jet with its substantially oval, in particular substantially elliptical jet shape has a longer tapered zone at the top and bottom in the spray image and is well suited mainly for quick applications, in particular because a greater amount of paint per surface area is applied than with the same painting speed.

This special configuration allows users of the set of nozzles according to the invention to choose the jet shape suitable for their mode of operation. If the user attaches greater importance to good controllability of the application, the user will choose one of the I-nozzle modules; if the user attaches greater importance to high painting speed, the user will choose one of the O-nozzle modules.

Both the first nozzle module group and the additional, or more specifically second, nozzle module group each have different nozzle modules which have different medium flow rates under the same spray conditions. At the same time, under the same spray conditions, the nozzle modules within one nozzle module group generate spray jets with substantially the same spray jet section height and the same spray jet section width, and in particular, the cross-sectional shape of the spray jet generated by means of the different nozzle modules within one group are congruent. Across multiple groups, the spray jet section height, the spray jet section width and/or shape of the cross sections of the spray jets can differ.

The set of nozzles preferably has at least one additional (third) nozzle module group which comprises at least two, preferably at least four, different nozzle modules for optional mounting in or on one and the same base module, with the nozzle modules of the additional nozzle module group also being designed such that they have different medium flow rates under the same spray conditions and that the spray jets generated by means of the nozzle modules have substantially the same spray jet section height and the same spray jet section width, and that, in particular, the spray jet sections of the different nozzle modules are congruent, with the nozzle modules of one nozzle module group being configured as low-pressure nozzle modules and the nozzle modules of the additional nozzle module group being configured as high-pressure nozzle modules.

Spray guns, especially paint spray guns, operate according to different pressure spray painting techniques. Conventional spray guns operate at relatively high spray pressures of several bar. In so-called HVLP guns, the internal nozzle pressure is at most 10 psi or 0.7 bar, which achieves transmission rates considerably higher than 65%. Compliant spray guns, on the other hand, have an internal nozzle pressure higher than 10 psi or 0.7 bar; however, they also achieve a transmission rate higher than 65%.

The internal nozzle pressure of the spray gun is defined as the pressure which exists in the air cap of the spray gun. Frequently, the atomizing air zone is separated from the horn air zone, and in the atomizing air zone, the pressure can be different from the pressure existing in the horn air zone. However, the pressures in the atomizing air zone and in the horn air zone can also be the same. The internal nozzle pressure can be measured, for example, by means of a so-called test air cap. This test air cap is a special air cap which is mounted on the spray gun instead of the conventional air cap. As a rule, the test air cap has two manometers, one of which is connected to the atomizing air zone via a bore in the test air cap, and the other manometer is connected to the horn air zone via an additional bore in the test air cap.

In this context, the terms low-pressure nozzle module and high-pressure nozzle module are not intended to suggest that the respective nozzle module is used only in conventional low-pressure or high-pressure spray guns or that by using the respective nozzle module, the spray gun is turned into a conventional low-pressure spray gun, in particular a HVLP spray gun, or into a conventional high-pressure gun. Instead, it only means that the spray gun, when fitted with a high-pressure nozzle module, has a higher internal nozzle pressure than when fitted with a low-pressure nozzle module. Preferably, a spray gun fitted with a low-pressure nozzle module or a base module fitted with a low-pressure nozzle module meets the criteria of an HVLP spray gun, and the spray gun fitted with a high-pressure nozzle module or a base module fitted with a high-pressure nozzle module meets the criteria of a compliant spray gun.

The fact that the nozzle modules of one nozzle module group are configured as low-pressure nozzle modules and the nozzle modules of the additional nozzle module group as high-pressure nozzle modules allows users to choose the nozzle module best suited to their mode of operation. If they attach more importance to high transmission rates and thus to a reduction of the amount of spray medium used, they will choose one of the low-pressure nozzle modules, in particular HVLP nozzle modules. If they attach more importance to a higher painting speed and/or if the compressor available to them is too small for the HVLP method, which requires a higher air volume than the compliant guns, they will choose one of the high-pressure nozzle modules, in particular compliant nozzle modules.

Most preferably, the spray jets generated by means of the low-pressure nozzle modules and the spray jets generated by means of the high-pressure nozzle modules have the same cross-sectional shape such that the spray jets generated by means of the low-pressure nozzle modules and the spray jets generated by means of the high-pressure nozzle modules have a cross section with, at least in certain areas, a substantially constant width (I-nozzle modules) or a cross section with a substantially oval, in particular substantially elliptical shape (O-nozzle modules). In this context, the term “same cross-sectional shape” refers to a same basic shape, or more specifically, the cross-sectional shape having, in at least in certain areas, a substantially constant width is a shape which is independent of different spray jet section heights, spray jet section widths or ratios of spray jet section height to spray jet section width. Similarly, the cross-sectional shape with a substantially oval, in particular substantially elliptical shape is a shape which is independent of different spray jet section heights, spray jet section widths or ratios of spray jet section height to spray jet section width.

As a result, a user who prefers an above-described I-jet has the option to choose between a low-pressure nozzle module and a high-pressure nozzle module, without having to give up a particularly preferred jet shape. The same applies mutatis mutandis to users who prefer an above-described O-jet.

Most preferably, the set of nozzles comprises at least two, preferably at least four, different nozzle module groups, with the nozzle modules of the nozzle module groups preferably being configured such that it is possible to dedicate, to each nozzle module of one nozzle module group, a nozzle module of at least one different nozzle module group or different nozzle module groups, which nozzle module has the same medium flow rate under the same spray conditions.

One of the nozzle module groups mentioned can comprise at least two, preferably at least four, different nozzle modules for optional mounting in or on one and the same base module, with all of the nozzle modules of this nozzle module group being configured as low-pressure nozzle modules, especially HVLP nozzle modules, and as I-nozzle modules, and with all of the spray jets, especially the spray jet sections, having the same spray jet section height, the same spray jet section width and the same cross-sectional shape, in particular with their spray jet sections being congruent. The individual nozzle modules within the nozzle module group each have different medium flow rates, especially different nozzle sizes, in particular different nominal nozzle sizes.

Another one of the nozzle module groups mentioned can comprise at least two, preferably at least four, different nozzle modules for optional mounting in or on one and the same base module, with all of the nozzle modules of this nozzle module group also being configured as low-pressure nozzle modules, especially HVLP nozzle modules, however not as I-nozzle modules but as O-nozzle modules, and with all of the spray jets of these nozzle modules, especially the spray jet sections, also having the same spray jet section height, the same spray jet section width and the same cross-sectional shape, in particular with their spray jet sections being congruent. The individual nozzle modules within the nozzle module group each have different medium flow rates, especially different nozzle sizes, in particular different nominal nozzle sizes.

Another one of the nozzle module groups mentioned can comprise at least two, preferably at least four, different nozzle modules for optional mounting in or on one and the same base module, with the nozzle modules of this nozzle module group not being configured as low-pressure nozzle modules, especially HVLP nozzle modules, but as high-pressure nozzle modules, especially compliant nozzle modules and also as O-nozzle modules, and with all of the spray jets of these nozzle modules, especially the spray jet sections, having the same spray jet section height, the same spray jet section width and the same cross-sectional shape, in particular with their spray jet sections being congruent. The individual nozzle modules within the nozzle module group each have different medium flow rates, especially different nozzle sizes, in particular different nominal nozzle sizes.

Yet another one of the nozzle module groups mentioned can comprise at least two, preferably at least four, different nozzle modules for optional mounting in or on one and the same base module, with the nozzle modules of this nozzle module group also being configured as high-pressure nozzle modules, especially compliant nozzle modules, however not has O-nozzle modules but as I-nozzle modules, and with all of the spray jets of these nozzle modules, especially the spray jet sections, having the same spray jet section height, the same spray jet section width and the same cross-sectional shape, in particular with their spray jet sections being congruent. The individual nozzle modules within the nozzle module group each have different medium flow rates, especially different nozzle sizes, in particular different nominal nozzle sizes.

The individual nozzle module groups can also stand alone and form a set of nozzles, or they can be combined with any other nozzle module group and as such form a set of nozzles. For example, the above nozzle module group referred to as the second nozzle module group can stand alone without the above-mentioned first nozzle module group and by itself form a set of nozzles, or the second nozzle module group and the third and/or fourth nozzle module group can form a set of nozzles without the first nozzle module group. The third and the fourth nozzle module group together can also form a set of nozzles without the first and second nozzle module group.

Configuring the nozzle modules of the nozzle module groups preferably such that, to each nozzle module of a nozzle module group, a nozzle module of at least one different nozzle module group or nozzle module groups can be dedicated, which nozzle module has the same medium flow rate under the same spray conditions, means that, for example, in at least two of the nozzle module groups, one nozzle module has a medium flow rate of 150 g/min.

Most preferably, the nozzle modules of the nozzle module groups are configured in such a way that, to each nozzle module of a nozzle module group, a nozzle module of at least one different nozzle module group or groups can be dedicated, which nozzle module has the same nozzle size, especially the same nominal nozzle size. For example, at least two, preferably four, of the nozzle module groups can have a 1.1 nozzle module, a 1.2 nozzle module, a 1.3 nozzle module and a 1.4 nozzle module.

The nozzle modules of a set of nozzles according to the invention preferably comprise at least one air cap, each with at least one internal horn air outlet aperture and one external horn air outlet aperture, wherein, from the at least one external horn air outlet aperture, horn air exits at a defined external horn air outflow angle relative to a vertical axis, with the vertical axis extending perpendicularly relative to a central axis of the first air cap, wherein, from the at least one internal horn air outlet aperture, horn air exits at a defined internal horn air outflow angle relative to the vertical axis, and wherein, in the different nozzle modules of at least one nozzle module group, the sums of the external horn air outflow angle and the internal horn air outflow angle within one nozzle module differ.

The above explanations in respect of the method according to the invention for embodying a nozzle module here apply mutatis mutandis. If in a first nozzle module of a nozzle module group, for example, the external horn air outflow angle relative to the vertical axis measures 16° and the internal horn air outflow angle relative to the vertical axis measures 21.5°, the sum of the external horn air outflow angle and the internal horn air outflow angle measures 37.5°. If in a second nozzle module of the same nozzle module group, for example, the external horn air outflow angle relative to the vertical axis measures 17° and the internal horn air outflow angle relative to the vertical axis measures 22°, the sum of the external horn air outflow angle and the internal horn air outflow angle measures 39°. For the sum of the external horn air outflow angle and the internal horn air outflow angle to be changed, it is obviously not necessary to change both the external horn air outflow angle and the internal horn air outflow angle; instead, it suffices to change only one of the angles. Most preferably, the sum of the external horn air outflow angle and the internal horn air outflow angle increases as the medium flow rate increases. More specifically, in the HVLP-nozzle modules with an I-jet, the sum mentioned can be between 37° and 44°, in the HVLP-nozzle modules with an O-jet, it can be between 36° and 41.5°, in the compliant nozzle modules with an I-jet, it can be between 44° and 46.5°, and in the compliant nozzle modules with an O-jet, it can be between 44.5° and 48.5°.

The nozzle modules of a set of nozzles according to the invention preferably each have at least one air cap, each with at least one central aperture and at least two control bores, with the control bores on opposite sides of the at least one central aperture being disposed, in particular, diametrically to each other and at a defined control bore distance relative to the at least one central aperture, characterized in that the control bore distance in the different nozzle modules of at least one nozzle module group is different.

The above explanations in respect of the method according to the invention for embodying a nozzle module here apply mutatis mutandis, especially the explanations in respect of the number and configuration of the control bores and the measurement of the control bore distance between the control bores and the central aperture.

The nozzle modules of a set of nozzles according to the invention preferably each have at least one spray medium nozzle with a substantially hollow-cylindrical front section and a spray medium outlet aperture, with the inside diameter of said outlet aperture and/or the axial extension of the substantially hollow-cylindrical front section of the spray medium nozzle being different in the different nozzle modules of at least one nozzle module group. Thus, a different medium flow rate is achieved.

The nozzle modules of a nozzle module group of a set of nozzles according to the invention are preferably configured in a such a way that the medium flow rate between nozzle modules consecutively following each other at increasing medium flow rates increases by an equidistant value, preferably by a value between 10 and 20 g/min, especially by a value of 15 g/min. This means that a nozzle module group comprises, for example, a 1.2 nozzle module and a 1.3 nozzle module, with the 1.2 nozzle module and the 1.3 nozzle module following one another at an increasing medium flow rate, which means that within the nozzle module group, the 1.3 nozzle module has the next higher medium flow rate relative to the 1.2 nozzle module, which means that within the nozzle module group, no nozzle module has a medium flow rate which is between the medium flow rate of the 1.2 nozzle module and the medium flow rate of the 1.3 nozzle module, and with the 1.3 nozzle, under the same spray conditions, having a medium flow rate which is higher by 10 to 20 g/min, preferably by 15 g/min. Most preferably, a nozzle module group comprises at least four nozzle modules which are configured such that under the same spray conditions, the medium flow rate between nozzle modules, which consecutively follow each other at an increasing medium flow rate, increases by an equidistant value, preferably by a value between 10 and 20 g/min, especially by a value of 15 g/min. A nozzle module group, for example, comprises a 1.1, a 1.2, a 1.3 and a 1.4 nozzle module, which nozzle modules follow each other at an increasing medium flow rate, with the medium flow rate, for example, of the 1.1 nozzle being 135 g/min, the medium flow rate of the 1.2 nozzle being 150 g/min, the medium flow rate of the 1.3 nozzle being 165 g/min and the medium flow rate of the 1.4 nozzle being 180 g/min. Such a medium flow rate which evenly increases with increasing nozzle size offers the user considerably advantages.

The method according to the invention for embodying a nozzle module preferably includes the production of the nozzle module. Most preferably, the method also includes the shipment of the nozzle module to the customer and the use of the nozzle module.

### BRIEF DESCRIPTION OF THE DRAWINGS

Embodiments of the invention will be explained in more detail below by way of example, with reference to the 5 figures. The figures show:

FIG. 1 a schematic representation of a spraying procedure;

FIG. 2 a schematic diagram of an example of a coating thickness profile across the height of the spray image;

FIG. 3 a table listing examples of nozzle modules of different nozzle module groups of an embodiment of a set of nozzles according to the invention;

FIG. 4 a sectional view of a first air cap of a nozzle module of an illustrative embodiment of a set of nozzles according to the invention, and

FIG. 5 a sectional view of a second air cap of a different nozzle module of an illustrative embodiment of a set of nozzles according to the invention.

### DETAILED DESCRIPTION

FIG. 1 shows a schematic representation of how a spray jet or, more specifically, a spray image 3 is generated by means of a spray gun 1 which here takes the form of a compressed-air atomizing paint spray gun. The spray gun 1 comprises, in particular, a base module 11 and a nozzle module 15 which is mounted on the base module 11. In the example at hand, the nozzle module 15 or, more specifically, the spray gun 1 with the nozzle module 15, generates an above-described O-jet; however, the situation for an I-jet is substantially the same. The figure does not show a realistic view; instead, the spray gun 1 is shown in a in a lateral view, and the spray image 3 is shown in a front view relative to the spray image 3. The broken lines illustrate the upper and lower outermost boundaries of the spray jet generated and the upper and lower outermost boundaries of the core of the spray jet. When striking a flat object which is disposed perpendicularly relative to the longitudinal axis Z and at a spraying distance d relative to the nozzle, especially relative to the front end of a spray medium nozzle, of the spray gun, the spray jet generates the spray image 3 with its outer spray jet zone 7 and its core or core zone 5. The outermost boundaries of the outer spray jet zone 7 and the transition between the outer spray jet zone 7 and the core zone 5 are fluid. In realistic spray images, however, at least the core zone 5 can, as a rule, be readily identified and measured. The core zone 5 has a defined height and a defined width, here referred to as spray jet section height h and spray jet section width b. Here, the longitudinal axis Z is a longitudinal axis of the upper part of the spray gun 1, a spraying axis, a longitudinal axis of the nozzle and a central axis of the air cap.

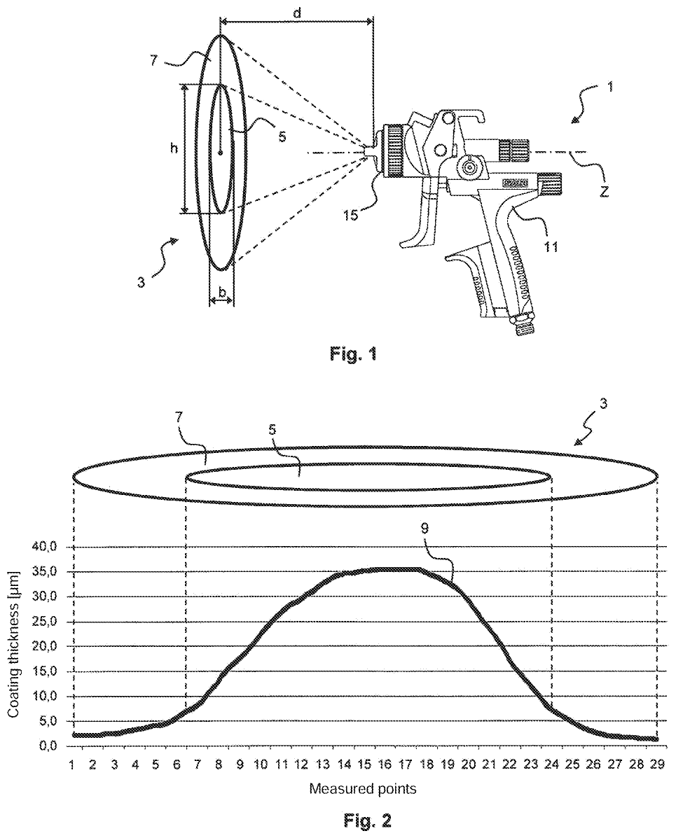

The spray jet 3 illustrated in FIG. 2 is shown rotated by 90° with respect to the representation in FIG. 1. FIG. 2 schematically shows an example of a coating thickness profile across the height of the entire spray jet. The curve 9 in the diagram shows an initially relatively flat slope of the coating thickness in pm in the outer spray jet zone 7. In the core zone 5, the coating thickness increases sharply, then reaches its peak and subsequently again drops sharply. In the outer spray jet zone 7, the curve 9 flattens again. The distance between the measured points, which form the X-axis of the diagram, here is not equal to 1 cm.

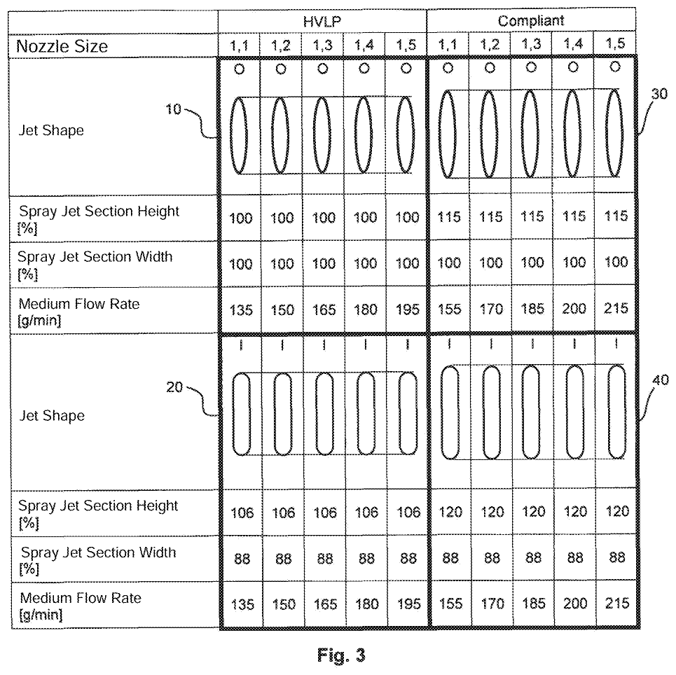

FIG. 3 shows a table with examples of different nozzle modules of different nozzle module groups 10, 20, 30, 40 of an embodiment of a set of nozzles according to the invention. In the table, the individual nozzle module groups 10, 20, 30, 40 are outlined in bold. The first nozzle module group 10 comprises five nozzle modules of different nozzle sizes, especially different nominal nozzle sizes. The medium flow rate of the five nozzle modules within the nozzle module group 10 increases from one nozzle size to the next by an equidistant value, i.e., 15 g/min. The 1.1 nozzle module has a medium flow rate of 135 g/min, the 1.2 nozzle module has a medium flow rate of 150 g/min, the 1.3 nozzle module has a medium flow rate of 165 g/min, the 1.4 nozzle module has a medium flow rate of 180 g/min, and the 1.5 nozzle module has a medium flow rate of 195 g/min. All nozzle modules within the nozzle module group 10 are configured as HVLP nozzle modules, i.e., as low-pressure nozzle modules, and all nozzle modules have the same spray jet section height and the same spray jet section width, which, as already mentioned above, are here defined as the spray jet section height h and the spray jet section width b of a core zone 5 illustrated in FIG. 1 and FIG. 2. The spray jet sections, i.e., the core zones 5 of the spray images generated by the nozzle modules within the nozzle module group 10, are congruent, i.e., they have the same shape and the same size. Only the coating thickness of the core zone 5 of the spray image would be different due to the different medium flow rate. The spray jet section height and the spray jet section width of the nozzle modules of the nozzle module group 10 serve as a reference for the spray jet section heights and spray jet section widths of the nozzle modules of the other nozzle module groups and are therefore shown at 100%. The nozzle modules of the nozzle module group 10 are configured in the form of the above-described O-nozzle modules, i.e., they each generate a spray jet, the cross section of which has a substantially oval, in particular substantially elliptical shape.

Thus, the user of an embodiment of a set of nozzles according to the invention, which comprises at least two nozzle modules of the nozzle module group 10, can change the nozzle size of the spray gun used, i.e., the user can remove the first nozzle module having a first nozzle size, in particular nominal nozzle size, mounted on the base module of the spray gun and mount a different nozzle module of the nozzle module group 10 having a different nozzle size, in particular nominal nozzle size, on the same base module, and achieve a spray jet with the same spray jet section height, spray jet section width and cross-sectional shape at a defined changed medium flow rate.

Another nozzle module group 20 also comprises five nozzle modules with different nozzle sizes, in particular different nominal nozzle sizes. The medium flow rate of the five nozzle modules within the nozzle module group 20 increases from one nozzle size to the next by an equidistant value, i.e., 15 g/min. The 1.1 nozzle module has a medium flow rate of 135 g/min, the 1.2 nozzle module has a medium flow rate of 150 g/min, the 1.3 nozzle module has a medium flow rate of 165 g/min, the 1.4 nozzle module has a medium flow rate of 180 g/min, and the 1.5 nozzle module has a medium flow rate of 195 g/min. All nozzle modules within the nozzle module group 20 are configured in the form of HVLP nozzle modules, i.e., as low-pressure nozzle modules, and all nozzle modules have the same spray jet section height and the same spray jet section width, which, as already mentioned above, are here defined as the spray jet section height h and the spray jet section width b of a core zone 5 illustrated in FIG. 1 and FIG. 2. The spray jet sections, i.e., the core zones 5 of the spray images generated by the nozzle modules within the nozzle module group 20, are congruent, i.e., they have the same shape and the same size. Only the coating thickness of the core zone 5 of the spray image would be different due to the different medium flow rate. The spray jet section height of the nozzle modules of the nozzle module group 20 is greater than the spray jet section height of the nozzle modules of the nozzle module group 10, in the example at hand, greater by 6%. The spray jet section width of the nozzle modules of the nozzle module group 20, on the other hand, is smaller than the spray jet section width of the nozzle modules of the nozzle module group 10, in the case at hand, it amounts to 88% of the spray jet section width of the nozzle modules of the nozzle module group 10. The nozzle modules of the nozzle module group 20 are configured in the form of the above-described I-nozzle modules, i.e., they each generate a spray jet, the cross section of which has, at least in certain areas, a substantially constant width.

Thus, the user of an embodiment of a set of nozzles according to the invention, which comprises at least two nozzle modules of the nozzle module group 20, can change the nozzle size of the spray gun used, i.e., the user can remove the first nozzle module having a first nozzle size, in particular nominal nozzle size, disposed on the base module of the spray gun and mount a different nozzle module of the nozzle module group 20 having a different nozzle size, in particular nominal nozzle size, on the same base module, and achieve a spray jet with the same spray jet section height, spray jet section width and cross-sectional shape at a defined changed medium flow rate.

Another nozzle module group 30 also comprises five nozzle modules with different nozzle sizes, in particular different nominal nozzle sizes. The medium flow rate of the five nozzle modules within the nozzle module group 30 increases from one nozzle size to the next by an equidistant value, i.e., 15 g/min. The 1.1 nozzle module has a medium flow rate of 155 g/min, the 1.2 nozzle module has a medium flow rate of 170 g/min, the 1.3 nozzle module has a medium flow rate of 185 g/min, the 1.4 nozzle module has a medium flow rate of 200 g/min, and the 1.5 nozzle module has a medium flow rate of 215 g/min. All nozzle modules within the nozzle module group 30 are configured as compliant nozzle modules, i.e., in the above understanding as high-pressure nozzle modules, and all nozzle modules have the same spray jet section height and the same spray jet section width, which, as already mentioned above, are here again defined as the spray jet section height h and the spray jet section width b of a core zone 5 illustrated in FIG. 1 and FIG. 2. The spray jet sections, i.e., the core zones 5 of the spray images generated by the nozzle modules within the nozzle module group 30, are congruent, i.e., they have the same shape and the same size. Only the coating thickness of the core zone 5 of the spray image would be different due to the different medium flow rate. The spray jet section height of the nozzle modules of the nozzle module group 30 is greater than the spray jet section height of the nozzle modules of the nozzle module group 10, in the example at hand, greater by 15%. The spray jet section width of the nozzle modules of the nozzle module group 30 is the same as the spray jet section width of the nozzle modules of the nozzle module group 10. The nozzle modules of the nozzle module group 30 are configured in the form of the above-described O-nozzle modules, i.e., they each generate a spray jet, the cross section of which has an oval, in particular substantially elliptical shape.

Thus, the user of an embodiment of a set of nozzles according to the invention, which comprises at least two nozzle modules of the nozzle module group 30, can change the nozzle size of the spray guns used, i.e., the user can remove the first nozzle module having a first nozzle size, in particular nominal nozzle size, mounted on the base module of the spray gun and mount a different nozzle module of the nozzle module group 30 having a different nozzle size, in particular nominal nozzle size, on the same base module, and achieve a spray jet with the same spray jet section height, spray jet section width and cross-sectional shape at a defined changed medium flow rate.

Another nozzle module group 40 also comprises five nozzle modules with different nozzle sizes, in particular different nominal nozzle sizes. The medium flow rate of the five nozzle modules within the nozzle module group 40 increases from one nozzle size to the next by an equidistant value, i.e., by 15 g/min. The 1.1 nozzle module has a medium flow rate of 155 g/min, the 1.2 nozzle module has a medium flow rate of 170 g/min, the 1.3 nozzle module has a medium flow rate of 185 g/min, the 1.4 nozzle module has a medium flow rate of 200 g/min, and the 1.5 nozzle module has a medium flow rate of 215 g/min. All nozzle modules within the nozzle module group 40 are configured as compliant nozzle modules, i.e., in the above understanding as high-pressure nozzle modules, and all nozzle modules have the same spray jet section height and the same spray jet section width, which, as already mentioned above, are here again defined as the spray jet section height h and the spray jet section width b of a core zone 5 illustrated in FIG. 1 and FIG. 2. The spray jet sections, i.e., the core zones 5 of the spray images generated by the nozzle modules within the nozzle module group 40, are congruent, i.e., they have the same shape and the same size. Only the coating thickness of the core zone 5 of the spray image would be different due to the different medium flow rate. The spray jet section height of the nozzle modules of the nozzle module group 40 is greater than the spray jet section height of the nozzle modules of the nozzle module group 10, in the example at hand, greater by 20%. The spray jet section width of the nozzle modules of the nozzle module group 40, on the other hand, is smaller than the spray jet section width of the nozzle modules of the nozzle module group 10, in the case at hand, it amounts to 88% of the spray jet section width of the nozzle modules of the nozzle module group 10. The nozzle modules of the nozzle module group 40 are configured in the form of the above-described I-nozzle modules, i.e., they each generate a spray jet, the cross section of which has, at least in certain areas, a substantially constant width.

Thus, the user of an embodiment of a set of nozzles according to the invention, which comprises at least two nozzle modules of the nozzle module group 40, can change the nozzle size of the spray guns used, i.e., the user can remove the first nozzle module having a first nozzle size, in particular nominal nozzle size, mounted on the base module of the spray gun and mount a different nozzle module of the nozzle module group 40 having a different nozzle size, in particular nominal nozzle size, on the same base module, and achieve a spray jet with the same spray jet section height, spray jet section width and cross-sectional shape at a defined changed medium flow rate.

A set of nozzles according to the invention for a spray gun, in particular a compressed-air atomizing paint spray gun, can comprise at least two, preferably at least four, different nozzle modules from the same nozzle module group for optional mounting in or on one and the same base module of a spray gun, which offers the user the advantages mentioned.

In addition, however, a set of nozzles according to the invention can each also have at least two, preferably at least four, different nozzle modules from one or a plurality of different nozzle module groups for optional mounting in or on one and the same base module. For example, a set of nozzles according to the invention can comprise at least two, preferably at least four, different nozzle modules from the nozzle module group 10 and at least two, preferably at least four, different nozzle modules from the nozzle module group 20 and/or at least two, preferably at least four, different nozzle modules from the nozzle module group 30 and/or at least two, preferably at least four, different nozzle modules from the nozzle module group 40.

Alternatively, a set of nozzles according to the invention can comprise, for example, at least two, preferably at least four, different nozzle modules from the nozzle module group 20 and at least two, preferably at least four, different nozzle modules from the nozzle module group 30 and/or at least two, preferably at least four, different nozzle modules from the nozzle module group 40.

Alternatively, a set of nozzles according to the invention can comprise, for example, at least two, preferably at least four, different nozzle modules from the nozzle module group 30 and at least two, preferably at least four, different nozzle modules from the nozzle module group 40.

A set of nozzles according to the invention can preferably comprise at least two, preferably at least four, different nozzle modules from three different nozzle module groups; most preferably, however, a set of nozzles according to the invention comprises at least two, preferably at least four, different nozzle modules from all four different nozzle module groups.

Each of the different nozzle modules from the different nozzle module groups can be interchangeably mounted on one and the same base module. To this end, most preferably, all of the nozzle modules from the different nozzle module groups have the same connecting means.

As the table indicates, in the set of nozzles according to the invention, to each nozzle module of a nozzle module group, a nozzle module of at least one different nozzle module group can be dedicated, which nozzle module has the same medium flow rate under the same spray conditions. The nozzle modules with the same nozzle size have the same medium flow rate, especially within one pressure spray painting technique. For example, the 1.1 HVLP O-nozzle module has the same medium flow rate of 135 g/min as the 1.1 HVLP I-nozzle module, the 1.2 HVLP O-nozzle module has the same medium flow rate as the 1.2 HVLP I-nozzle module and so on. The same applies to the compliant nozzle modules. For example, the 1.1 compliant O-nozzle module has the same medium flow rate of 155 g/min as the 1.1 compliant I-nozzle module, the 1.2 compliant O-nozzle module has the same medium flow rate as the 1.2 compliant I-nozzle module and so on.

The table further indicates that the spray jets generated by means of the low-pressure nozzle modules, here HVLP-nozzle modules, and the spray jets generated by means of the high-pressure nozzle modules, here compliant nozzle modules, can have the same cross-sectional shape, in particular such that the spray jets generated by means of the low-pressure nozzle modules and the spray jets generated by means of the high-pressure nozzle modules have a cross section with, at least in certain parts, a substantially constant width (I-nozzle modules) or a cross section with a substantially oval, in particular substantially elliptical shape (O-nozzle modules). This allows the user to exchange, for example, a nozzle module from the nozzle module group 10 for a nozzle module from the nozzle module group 30, and thus to switch from the low-pressure spraying method, in particular HVLP spraying method, to the high-pressure spraying method, in particular compliant spraying method, without having to do without the O-jet, which is ideal for the user's mode of operation. Similarly, the user can exchange a nozzle module from the nozzle module group 20 for a nozzle module from the nozzle module group 40, and thus to switch from the low-pressure spraying method, in particular HVLP spraying method, to the high-pressure spraying method, in particular compliant spraying method, without having to do without the I-jet, which is ideal for the user's mode of operation.

In addition to the advantages mentioned above, the set of nozzles according to the present invention has the additional advantage that the user can exchange, for example, a nozzle module from the nozzle module group 10 for a nozzle module from the nozzle module group 20, and thus is able to replace a nozzle module which generates an O-jet, which allows a fast coating application, for a nozzle module which generates an even more readily controllable I-jet, without having to give up working with the desired HVLP type of pressure spray painting technique and, in particular, without having to accept changes in the medium flow rate as a tradeoff. Similarly, it is possible to switch from a nozzle module from the nozzle module group 30 to a nozzle module from the nozzle module group 40, without having to give up the desired compliant pressure spray painting technique and, in particular, without having to accept changes in the medium flow rate as a tradeoff. Vice versa switches are, of course, possible as well.

Using the set of nozzles according to the invention, the user can choose the nozzle module ideal for the painting job at hand and/or the mode of operation desired. As a rule, the ideal nozzle module can be selected based on a number of different attributes, especially based on the previously used nozzle module of a set of nozzles according to the invention, on the previously used nozzle module of a different set of nozzles, on the type of pressure spray painting technique desired, on the spray gun model to be used, the manufacturer of the spray gun to be used, the type of medium to be sprayed, the viscosity of the medium to be sprayed, the recommendation of the manufacturer of the medium to be sprayed, the desired shape of the spray jet, the coating thickness required, the ambient conditions, especially the temperature and the relative air humidity inside the painting booth, based on whether the user attaches greater importance to the painting speed or to good controllability of the coating application, and/or on the nozzle size desired. When making this selection, in particular, the method according to the invention for selecting a nozzle module from a set of nozzles for a paint job, the selection system and/or the inventive computer program product according to the invention is/are helpful.

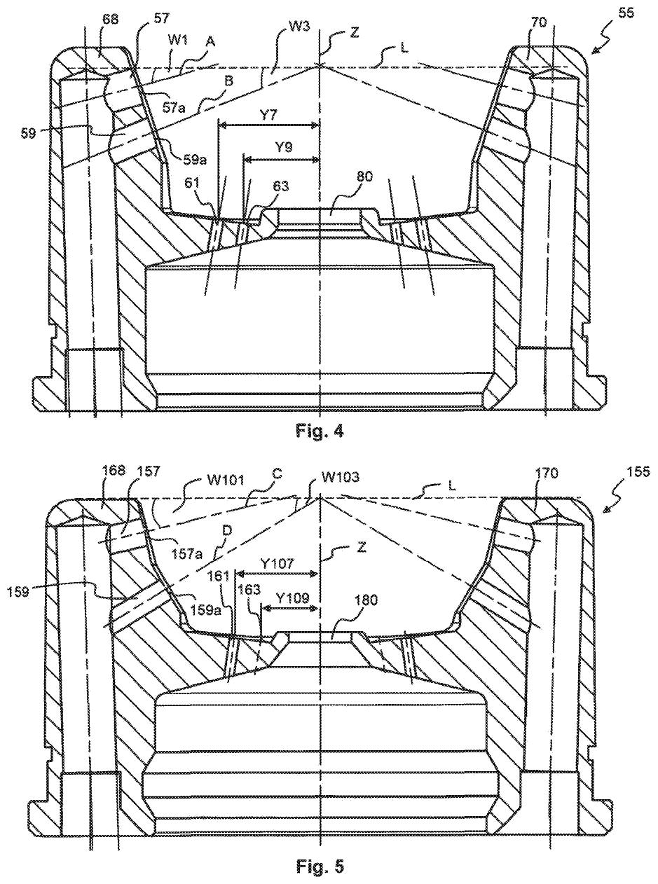

FIG. 4 shows a sectional view of a first air cap 55 of a nozzle module of an embodiment of a set of nozzles according to the invention. The air cap 55 comprises a first horn 68 and a second horn 70. A vertical axis L extends perpendicularly relative to the central axis Z of the first air cap 55, with the central axis Z extending through the center of the central aperture 80. The central axis A of an external horn air outlet channel 57 forms a defined angle with the vertical axis L, and the central axis B of an internal horn air outlet channel 59 forms a defined second angle with the vertical axis L. In the present embodiment, it can be assumed that the major portion of the horn air, which flows out of the external horn air outlet aperture 57a of the external horn air outlet channel 57, follows the central axis A of the external horn air outlet channel 57, and that the center of this horn air jet is located on the central axis A of the external horn air outlet channel 57. Similarly, it can also be assumed that the major portion of the horn air, which flows out of the internal horn air outlet aperture 59a of the internal horn air outlet channel 59, follows the central axis B of the internal horn air outlet channel 59, and that the center of this horn air jet is located on the central axis B of the internal horn air outlet channel 59. The angle, which the central axis A of the external horn air outlet channel 57 forms with the vertical axis L, can therefore be referred to as the external horn air outflow angle W1, and the angle, which the central axis B of the internal horn air outlet channel 59 forms with the vertical axis L, can be referred to as the internal horn air outflow angle W3. Preferably, the horn air outlet channels of the second horn 70 lying opposite to the horn air outlet channels mentioned form the same angles with the vertical axis L.

FIG. 4 further shows the external control bore 61 and the internal control bore 63 which are located, respectively, at an external control bore distance Y7 and an internal control bore distance Y9 relative to the central axis Z of the first air cap 55.

FIG. 5 shows a sectional view of a second air cap 155 of a different nozzle module of an embodiment of a set of nozzles according to the invention. The air cap 155 comprises a first horn 168 and a second horn 170. Here again, the vertical axis L extends perpendicularly relative to the central axis Z of the second air cap 155, with the central axis Z extending through the center of the central aperture 180. The central axis C of an external horn air outlet channel 157 forms a defined angle with the vertical axis L, and the central axis D of an internal horn air outlet channel 159 forms a second angle with the vertical axis L. In the embodiment at hand, it can again be assumed that the main portion of the horn air, which flows out of the external horn air outlet aperture 157a of the external horn air outlet channel 157, follows the central axis C of the external horn air outlet channel 157 and that the center of this horn air jet is located on the central axis C of the external horn air outlet channel 157. Similarly, it can be assumed that the main portion of the horn air, which flows out of the internal horn air outlet aperture 159a of the internal horn air outlet channel 159, follows the central axis D of the internal horn air outlet channel 159 and that the center of this horn air jet is located on the central axis D of the internal horn air outlet channel 159. The angle, which the central axis C of an external horn air outlet channel 157 forms with the vertical axis L, can therefore be referred to as the external horn air outflow angle W101, and the angle, which the central axis D of an internal horn air outlet channel 159 forms with the vertical axis L, can be referred to as the internal horn air outflow angle W103. Preferably, the horn air outlet channels of the second horn 170 lying opposite to the horn air outlet channels mentioned form the same angles with the vertical axis L.

FIG. 5 also shows an external control bore 161 which is located at an external control bore distance Y107 relative to the central axis Z of the second air cap 155. Since the control bores in this air cap 155 are arranged in the form of a triangle—wherein the apex of the triangle is oriented in the direction of the internal or the external horn air outlet apertures, i.e., only the control bore 161, which forms the apex of the triangle, is in line with the internal horn air outlet aperture 159a, the external horn air outlet aperture 157a and the center of the central aperture 180 in the air cap 155, and the sectional plane extends only through the control bore 161, the internal horn air outlet aperture 159a and the external horn air outlet aperture 157a—the two other control bores on one side of the central aperture 180 and the two other control bores on the other side of the central aperture 180 are not visible, but are here only tentatively identified by their central axes. The internal control bore distance Y109 is the distance between the central axis Z and an axis extending parallel to this central axis Z through a projection of the center of the respective control bore onto the sectional plane.

In a nozzle module with the air cap 55, the sum of the angles W1 plus W3 can differ from the sum of the angles W101 plus W103 in a different nozzle module with the air cap 155. The nozzle modules can be part of the same nozzle module group.

Finally, it should be noted that the illustrative embodiments discussed describe only a limited number of possible embodiments and therefore in no way constitute a limitation of the present invention.

1-15. (canceled)

16. A set of nozzles for a spray gun, the set comprising at least one nozzle module group with at least two different nozzle modules for mounting in or on one and the same base module of a spray gun, wherein the nozzle modules are designed such that the nozzle modules have different medium flow rates under the same spray conditions, with spray jets generated by the nozzle modules having substantially the same spray jet section height and substantially the same spray jet section width, with the spray jet sections of the different nozzle modules being congruent.

17. The set of nozzles as in claim 16, wherein the set of nozzles further includes at least one additional nozzle module group which comprises at least two, different nozzle modules for mounting in or on one and the same base module, with the nozzle modules of the additional nozzle module group being designed such that the nozzle modules of the additional nozzle module group have different medium flow rates under the same spray conditions and that the spray jets generated by the nozzle modules have substantially the same spray jet section height and substantially the same spray jet section width, with the spray jet sections of the different nozzle modules being congruent, with the spray jets generated by the nozzle modules of the two nozzle module groups each having different cross-sectional shapes, such that the spray jets generated by the nozzle modules of one nozzle module group have a cross section with, in at least in certain parts, a substantially constant width and the spray jets generated by the nozzle modules of the other nozzle module group have a cross section with a substantially oval shape.

18. The set of nozzles as in claim 17, wherein the set of nozzles further has at least one additional (third) nozzle module group which comprises at least two different nozzle modules for mounting in or on one and the same base module, with the nozzle modules of the additional nozzle module group being designed such that the nozzle modules of the third nozzle module group have different flow rates under the same spray conditions and wherein the spray jets generated by the nozzle modules have substantially the same spray jet section height and substantially the same spray jet section width, such that the spray jet sections of the different nozzle modules are congruent, with the nozzle modules of one nozzle module group being configured as low-pressure nozzle modules and the nozzle modules of the additional nozzle module group being configured as high-pressure nozzle modules.

19. The set of nozzles as in claim 18, wherein the spray jets generated by the low-pressure nozzle modules and the spray jets generated by the high-pressure nozzle modules have the same cross-sectional shape, with, at least in certain parts, a substantially constant width or a cross section with a substantially oval shape.

20. The set of nozzles as in claim 16, wherein the set of nozzles has at least two different nozzle module groups, with the nozzle modules of the nozzle module groups being designed such that, to each nozzle module of a nozzle module group, a nozzle module of at least one other nozzle module group or groups can be dedicated, which nozzle module has the same medium flow rate under the same spray conditions.

21. The set of nozzles as in claim 16, wherein the nozzle modules each comprises at least one air cap, each with at least two horns with at least one internal horn air outlet aperture and one external horn air outlet aperture, wherein horn air flows out of the at least one external horn air outlet aperture at a defined external horn air outflow angle relative to a vertical axis, with the vertical axis extending perpendicularly relative to a central axis of the air cap, wherein horn air flows out of the at least one internal horn air outlet aperture at a defined internal horn air outflow angle relative to the vertical axis, and wherein the sums of the external horn air outflow angle and the internal horn air outflow angle within a nozzle module are different in the different nozzle modules of at least one nozzle module group.

22. The set of nozzles as in claim 16, wherein the nozzle modules each have at least one air cap, each with at least one central aperture and at least two control bores, with the control bores being arranged diametrically to each other on opposite sides of the at least one central aperture and at a defined control bore distance relative to the at least one central aperture, wherein the control bore distance in the different nozzle modules of at least one nozzle module group is different.

23. The set of nozzles as in claim 16, wherein the nozzle modules each have at least one spray medium nozzle with a substantially hollow-cylindrical front section and a spray medium outlet aperture, with the inside diameter of the spray medium outlet aperture and/or the axial extension of the substantially hollow-cylindrical front section of the spray medium nozzle being different in the different nozzle modules of at least one nozzle module group.

24. The set of nozzles as in claim 16, wherein the nozzle modules of a nozzle module group are designed such that, under the same spray conditions, the medium flow rate between nozzle modules, which consecutively follow each other at increasing medium flow rates, each increases by an equidistant value.

25. A spray gun system, wherein the spray gun system comprises at least one set of nozzles as in claim 16 and a base module, with the nozzle modules of the set of nozzles being interchangeably mounted on the base module.

26. A method for embodying a nozzle module for a set of nozzles as in claim 16, the method comprising:
specifying at least one spray jet section height and/or one spray jet section width and/or one cross-sectional shape of a spray jet to be generated by the nozzle module,
constructing the nozzle module which generates a spray jet with the defined spray jet section height and/or spray jet section width and/or shape of the spray jet section,
wherein construing the nozzle module includes constructing an air cap by adapting an external horn air outflow angle and/or an internal horn air outflow angle and/or a control bore distance to a medium flow rate and/or to an internal nozzle pressure of the nozzle module, with the external horn air outflow angle being the angle, at which horn air flows out of an external horn air aperture of the air cap relative to a vertical axis, with the vertical axis extending at right angles relative to a central axis of the air cap, with the internal horn air outflow angle being the angle, at which horn air flows out of an internal horn air outlet aperture of the air cap relative to the vertical axis, and with the control bore distance being the distance between at least one control bore in the air cap and a central aperture in the air cap.

27. The method as in claim 26, wherein the method includes producing the nozzle module.

28. A method for selecting a nozzle module from a set of nozzles as in claim 16 for a paint job, the method comprising selecting and/or specifying one or a plurality of the following attributes of the painting job: the previously used nozzle module of a set of nozzles, the previously used nozzle module of a different set of nozzles, the pressure spray painting technique, the spray gun model, the spray gun manufacturer, the type of medium to be sprayed, the viscosity of the medium to be sprayed, the recommendation of the manufacturer of the medium to be sprayed, the shape of the spray jet, the coating thickness, the ambient condition, the painting speed, the controllability, the nozzle size, and wherein, based on the selection and/or specification, a proposal for a nozzle module of the set of nozzles is generated.

29. A selection system, for implementing the method as in claim 28, wherein the system comprises selection and input means for selecting and inputting attributes of the paint job and means for generating and displaying a proposal for a nozzle module of the set of nozzles.

30. A computer program product, wherein the computer program product comprises commands which, during execution of the program by a data processing device, cause the program to generate a method of the selection system as in claim 29.
